(19) United States
(12) Patent Application Publication
(10) Pub. No.: US 2026/0144688 A1
(43) Pub. Date: May 28, 2026

(54) PATIENT SUPPORT SURFACE WITH ANATOMICAL TURN INSERT

(71) Applicant: UMANO MEDICAL INC., L'Islet (CA)

(72) Inventors: Sylvain LACASSE, Quebec (CA); Pascal POULIN, Levis (CA); Andre GUILLEMETTE, Lévis (CA); Charles GRAVEL, Québec (CA)

(73) Assignee: UMANO MEDICAL INC., L'Islet (CA)

(21) Appl. No.: 19/389,145

(22) Filed: Nov. 14, 2025

Related U.S. Application Data
(60) Provisional application No. 63/724,678, filed on Nov. 25, 2024.

(51) Int. Cl. A61G 7/00; A61G 7/057; A61G 7/07

(52) U.S. Cl. CPC A61G 7/001; A61G 7/05776; A61G 7/07

(57) ABSTRACT

A support surface for a patient support apparatus includes: a comfort layer for supporting a patient on the support surface; a support layer disposed below the comfort layer and contributing to support the patient on the support surface; a cover enclosing the comfort layer and the support layer; and an anatomical turn insert including a turn bladder having a plurality of portions that are adapted to tilt specific parts of the patient's body, for example during a turn-assist or a continuous lateral rotation therapy (CLRT) function. The anatomical turn insert may also be provided as an independent component selectively placed within, beneath, or on the mattress.

### CROSS-REFERENCE

The present application claims priority from U.S. Provisional Ser. No. 63/724,678 filed Nov. 25, 2024, the entirety of which is incorporated by reference herein.

### TECHNICAL FIELD

The present disclosure relates to patient support surfaces. More particularly, the present disclosure concerns patient support surfaces equipped with a system to assist in turning a patient lying on the bed.

### BACKGROUND

Regular repositioning of patients lying on hospital beds is needed to help prevent different medical conditions such as the development of pressure ulcers caused by prolonged bed rest in the same position. However, nurses and other caregivers experience an increased risk of musculoskeletal back or shoulder injuries when performing manual repositioning of patients such as manual turning of patients. There is therefore a need for a turn-assist system to help caregivers safely reposition the patients.

Some patient support surfaces (mattresses) used in medical environments, have turn bladders that help the caregivers by providing a turn-assist function, useful in turning a patient towards their right side or their left side. Some mattresses also have a continuous lateral rotation therapy (CLRT) function, used for continuously turning the patient on their left and right side alternately.

Prior art turn bladders are typically cylindrical air cells that are arranged on both lateral sides of the mattress in a longitudinal direction of the patient support surface. These turn bladders may not be adapted to provide optimal comfort for patients, as the contact area between the turn bladders and the patient is limited. Consequently, the pressure applied on a section of the patient's back is significant. Furthermore, these cylindrical air cells may not be sufficient to effectively turn the patient, especially if the weight of the patient is substantial in the torso or seat area.

In view of the foregoing, there is a need for a support surface that addresses at least some of these drawbacks.

### SUMMARY

It is an object of the present disclosure to address at least one of the inconveniences present in the prior art.

According to an aspect of the present disclosure, there is provided a support surface for a patient support apparatus includes: a comfort layer for supporting a patient on the support surface; a support layer disposed below the comfort layer and contributing to support the patient on the support surface; a cover enclosing the comfort layer and the support layer; and an anatomical turn insert including a turn bladder having a plurality of portions that are adapted to tilt specific parts of the patient's body, for example during a turn-assist or a continuous lateral rotation therapy (CLRT) function. In some embodiments, the anatomical turn insert is provided as an independent component selectively placed within, beneath, or on the mattress.

According to an aspect of the present disclosure, there is provided a support surface for a patient support apparatus. The support surface has a head section, a back section, a thigh section, and a foot section arranged respectively from a head end to a foot end of the support surface along a longitudinal direction of the support surface and has a right side and a left side defining a width of the support surface. The right side and the left side are disposed on opposite sides of a central plane of the support surface, the central plane extending parallel to the longitudinal direction and bisecting the width of the support surface.

The support surface comprises a core having a first layer and an anatomical turn insert, the anatomical turn insert being vertically adjacent to the first layer and having a first turn bladder and a second turn bladder, each being substantially arranged on one of the left side and the right side of the support surface and being substantially in mirror symmetry relative to the central plane. The first turn bladder has a first plurality of portions including a longitudinal torso portion extending substantially parallel to the longitudinal direction near the back section, and an oblique thigh portion coupled to and extending obliquely from the longitudinal torso portion near the thigh section. The second turn bladder has a second plurality of portions being substantially in mirror symmetry to the first plurality of portions relative to the central plane.

The support surface also comprises a cover. The cover has a top surface, a bottom surface, and peripheral surfaces extending from the top surface and connecting to the bottom surface thereby enclosing the core.

The support surface also comprises a pneumatic control assembly having a controller operable to selectively control inflation and deflation of the first plurality of portions and the second plurality of portions.

In some embodiments, the first plurality of portions further includes a shoulder support portion coupled to and disposed vertically adjacent to the longitudinal torso portion near the head section, the first plurality of portions thereby including two vertically superposed layers.

In some embodiments, the first plurality of portions further includes a transversal head portion coupled to and substantially perpendicular to the longitudinal torso portion near the head section, the first plurality of portions thereby having a generally C-shaped configuration.

In some embodiments, the first plurality of portions further includes a transversal head portion and a shoulder support portion, the transversal head portion being coupled to and substantially perpendicular to the longitudinal torso portion near the head section and the shoulder support portion being coupled to and disposed vertically adjacent to the longitudinal torso portion, near the transversal head portion.

In some embodiments, the first layer is provided between the top surface and the anatomical turn insert.

In some embodiments, the support surface comprises a securing member to couple the anatomical turn insert to at least one of the core and the cover.

In some embodiments, the securing member is affixed to at least one of an additional section of material of the longitudinal torso portion of the turn bladder and an intermediate layer at least partially connected to the turn bladder.

In some embodiments, the anatomical turn insert further comprises at least one connecting member operable to connect the first turn bladder to the second turn bladder.

In some embodiments, the core further comprises a second layer located vertically under the anatomical turn insert, wherein the anatomical turn insert is provided between the first layer and the second layer.

In some embodiments, at least one of the first layer and the second layer comprises at least one inflatable bladder.

In some embodiments, the first layer is a comfort layer and the second layer is a support layer.

In some embodiments, the first plurality of portions forms a single pneumatic zone, the controller being operable to selectively inflate or deflate the first plurality of portions integrally. In some embodiments, the first plurality of portions forms a plurality of independent pneumatic zones, the controller being operable to selectively inflate and deflate each one of the independent pneumatic zones individually.

In some embodiments, the controller is programmed to control an alternating inflation and deflation cycle, the cycle comprising inflating the first plurality of portions to a first predetermined pressure, maintaining the first plurality of portions inflated at the first predetermined pressure for a first predetermined period of time, deflating the first plurality of portions, maintaining the first plurality of portions deflated for a second predetermined period of time, inflating the second plurality of portions to a second predetermined pressure, maintaining the second plurality of portions inflated at the second predetermined pressure for a third predetermined period of time, deflating the second plurality of portions, maintaining the first plurality of portions deflated for a fourth predetermined period of time, and repeating the alternating inflation and deflation cycle continuously, a continuous lateral rotation therapy thereby being applied to a patient.

In some embodiments, at least one of the first predetermined period of time, the second predetermined period of time, the third predetermined period of time, and the fourth predetermined period of time is 0 second.

In some embodiments, the pneumatic control assembly further includes a first blower and a second blower, the controller being operable to enable the first blower to provide air at a first flow rate and a first pressure, and the second blower at a second flow rate and a second pressure.

In some embodiments, the first blower is fluidly connected to the second blower and the second blower is fluidly connected to the anatomical turn insert, the controller being operable to enable the first blower to pump air towards the second blower thereby providing pumped air, the second blower receiving the pumped air from the first blower, the controller being operable to enable the second blower to pump the pumped air to the anatomical turn insert, the anatomical turn insert thereby receiving air at a third flow rate and a third pressure, the third flow rate being greater than each of the first flow rate and the second flow rate and the third pressure being greater than each of the first pressure and the second pressure.

According to another aspect of the present disclosure, there is provided an anatomical turn insert for a support surface for a patient support apparatus. The anatomical turn insert comprises at least one turn bladder being pneumatically inflatable, the at least one turn bladder having a plurality of portions, the plurality of portions including a longitudinal torso portion having a first end and a second end and forming an elongated body, and an oblique thigh portion coupled to and extending obliquely from the longitudinal torso portion near to the first end.

In some embodiments, the plurality of portions further comprises a shoulder support portion coupled to and disposed vertically adjacent to the longitudinal torso portion near the second end, the plurality of portions thereby including two vertically superposed layers.

In some embodiments, the plurality of portions further comprises a transversal head portion coupled to and substantially perpendicular to the longitudinal torso portion near the second end, the plurality of portions thereby having a generally C-shaped configuration.

In some embodiments, the plurality of portions further comprises a transversal head portion and a shoulder support portion, the transversal head portion being coupled to and substantially perpendicular to the longitudinal torso portion near the second end and the shoulder support portion being coupled to and disposed vertically adjacent to the longitudinal torso portion, near the transversal head portion.

According to another aspect of the present disclosure, there is provided a method for providing a turn assist to a patient. The method comprises providing the anatomical turn insert as described herein, inflating the at least one portion of the at least one turn bladder to a first predetermined pressure, and maintaining the at least one portion inflated at the first predetermined pressure for a first predetermined period of time.

In some embodiments, the method further comprises deflating the at least one portion of the at least one turn bladder and maintaining the at least one portion in a deflated state for a second predetermined period of time.

In some embodiments, the at least one turn bladder includes a first turn bladder and a second turn bladder, the method further comprising performing the inflating, and deflating of the first turn bladder in a temporally offset manner relative to the steps of inflating and deflating of the second turn bladder, the method being operable to provide continuous lateral rotation therapy to the patient.

Embodiments of the present disclosure each have at least one of the above-mentioned objects and/or aspects, but do not necessarily have all of them. It should be understood that some aspects of the present disclosure that have resulted from attempting to attain the above-mentioned objects may not satisfy these objects and/or may satisfy other objects not specifically recited herein.

Additional and/or alternative features, aspects and advantages of embodiments of the present disclosure will become apparent from the following description.

### BRIEF DESCRIPTION OF THE DRAWINGS

Having thus generally described the nature of the present disclosure, reference will now be made to the accompanying drawings, showing by way of illustration example embodiments thereof and in which:

FIG. 1 is a cross-sectional view of a simplified exemplary mattress according to an embodiment showing a turn bladder in a deflated state;

FIG. 2 is a perspective exploded view of an exemplary mattress according to another embodiment;

FIG. 3 is a cross-sectional view of the mattress of FIG. 1 showing a turn bladder in an inflated stated;

FIG. 4 is a perspective view of an anatomical turn insert of the mattress of FIG. 2;

FIG. 5 is a top view of an anatomical turn insert with one of the two turn bladders being inflated and the other one of the two turn bladders being deflated, the turn bladders being connected by a longitudinal patch;

FIG. 6 is a front view of one turn bladder of the mattress of FIG. 2 in an embodiment having a plurality of portions with a longitudinal torso portion, an oblique thigh portion, a transversal head portion and a shoulder support portion;

FIG. 7 is a front view of one simplified turn bladder in another embodiment having a plurality of portions with a longitudinal torso portion and an oblique thigh portion, and without a transversal head portion nor a shoulder support portion;

FIG. 8 is a front view of a turn bladder in another embodiment having a plurality of portions with a longitudinal torso portion, an oblique thigh portion, and a shoulder support portion, and without a transversal head portion;

FIG. 9 is a front view of a turn bladder in another embodiment having a plurality of portions with a longitudinal torso portion, an oblique thigh portion, and a transversal head portion, and without a shoulder support portion;

FIG. 10 includes FIG. 10A and FIG. 10B in which FIG. 10A is a perspective view of an anatomical turn insert in another embodiment without a transversal head portion and having an additional section of material extending from a turn bladder and FIG. 10B is a rear view of the anatomical turn insert of FIG. 10 A;

FIG. 11 includes FIG. 11A and FIG. 11B in which FIG. 11A is a front view of an anatomical turn insert in another embodiment without a transversal head portion and having an intermediate layer affixed to a turn bladder and FIG. 11B is a rear view of the anatomical turn insert of FIG. 11A;

FIG. 12 is a simplified schematic diagram of a pneumatic system of the pneumatic control assembly controlling one of the turn bladders;

FIG. 13 is a flowchart of example steps of a method of providing a continuous lateral rotation therapy (CLRT) in accordance with an embodiment;

FIG. 14 is a screenshot of an example of a turn-assist function home screen on a Graphical User Input (GUI);

FIG. 15 is a screenshot of an example of a progress screen for the turn-assist function on a GUI; and

FIG. 16 is a screenshot of an example of a CLRT function home screen on a GUI.

It will be noted that throughout the appended drawings, like features are identified by like reference numerals. To not unduly encumber the figures, some elements may not be indicated in some figures if they were already identified in a preceding figure. It should be understood herein that elements of the drawings are not necessarily depicted to scale. Some mechanical or other physical components may also be omitted in order to not encumber the figures.

### DETAILED DESCRIPTION

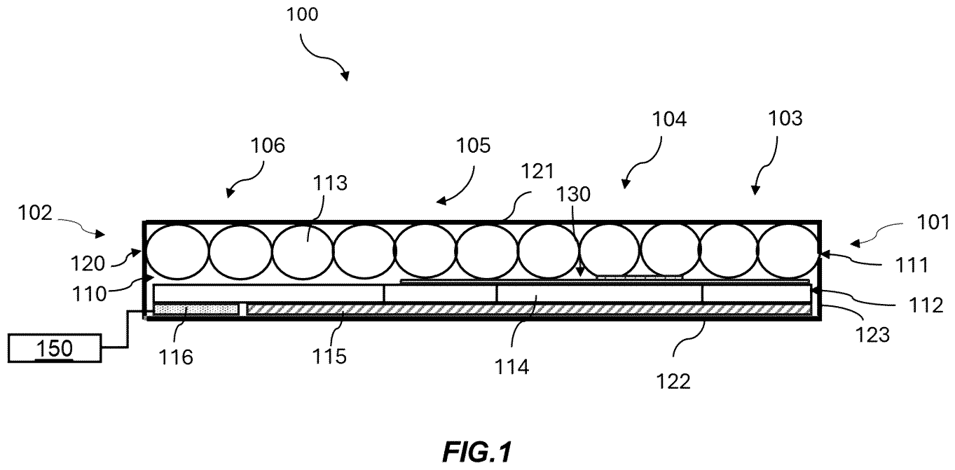

A mattress 100 in accordance with an embodiment of the present disclosure is illustrated in FIG. 1 and will be described herein. The mattress 100 may be used in a medical setting for supporting a patient. The mattress 100 may alternatively be referred to as a “support surface”. The mattress 100 is usable in combination with a patient support apparatus (not shown) such as a hospital bed for use in different medical settings, for example an intensive care unit (ICU) bed, a medical and surgery (medsurg) bed or a therapeutic bed.

The mattress 100 has a head end 101 and a foot end 102 opposite the head end 101 and defining a length of the mattress 100 therebetween. As will be appreciated, in use, when the patient is lying on the mattress 100, the patient's head is closer to the head end 101 while the patient's feet are closer to the foot end 102. As shown in FIG. 1, a head section 103, a back section 104, a thigh section 105 and a foot section 106 are arranged respectively from the head end 101 to the foot end 102 along a longitudinal direction 109 of the mattress 100. The mattress 100 also has laterally opposite left side 107 and right side 108 extending between the head end 101 and the foot end 102 and defining a width of the mattress 100. More precisely, the left side 107 and the right side 108 are laterally disposed on opposite sides of a central plane (CS) of the support surface, the central plane extending parallel to the longitudinal direction 109 and bisecting the width of the mattress 100.

Some of the structural components of the mattress 100 will be designated hereinafter as “right”, “left”, “head”, “foot”, “back”, “torso”, “thigh” and “shoulder” from the reference point of an individual lying on their back on the mattress 100 with their head oriented toward the head end 101 of the mattress 100 and their feet oriented toward the foot end 102 of the mattress 100.

The mattress 100 has a mattress core 110 and a mattress cover 120 enclosing the mattress core 110. The mattress core 110 provides support and comfort for the patient and may include pneumatic layers, foam or latex layers, spring or coil layers, material or fiber layers or any combination thereof.

In this embodiment, the mattress core 110 includes a first layer and a second layer. The first layer can be referred to as a comfort layer 111. The second layer can be referred to as a support layer 112. Comfort layer 111 is disposed above support layer 112. The support layer 112 provides a base for the mattress core 110 while the comfort layer 111 is in more direct contact with a patient lying on the mattress 100 when in use as it is closer to a top surface of the cover 120. The comfort layer 111, supported by the support layer 112, contributes to the comfort of the patient and helps prevent them from developing bed sores. Together, both layers 111, 112 support the patient on the mattress 100 and contribute to providing comfort. It is contemplated that, in some embodiments, a single one or multiple ones of the layers 111, 112 may be provided.

In this embodiment, the comfort layer 111 includes a plurality of inflatable comfort bladders 113 that can be selectively inflated and deflated. In one example embodiment, the inflatable comfort bladders 113 are transversally oriented (i.e., they extend in a transversal direction across the width of the mattress 100). It is contemplated that the inflatable comfort bladders 113 could be oriented differently in other embodiments. The inflatable comfort bladders 113 may have a cylindrical shape, but other shapes may be used. In this embodiment, the inflatable comfort bladders 113 are mounted together side by side and extend transversally across the width of the mattress 100. The bladders can be grouped in sections or provided independently. The whole series of inflatable comfort bladders 113 is considered to form the first layer.

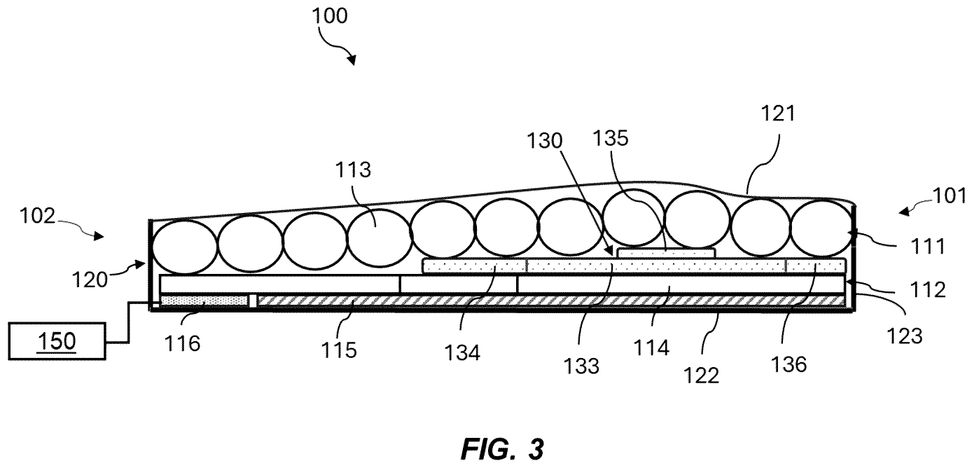

The support layer 112 includes a plurality of inflatable support bladders 114. The inflatable support bladders 114 are longitudinally oriented (i.e., they extend in a longitudinal direction of the mattress 100). The inflatable support bladders 114 could be oriented differently in other embodiments. The support bladders have a length which is not necessarily the full length of the mattress. Indeed, the support bladders can be provided in portions which cover a partial length of the mattress. In the example embodiment of FIG. 3, there are at least two support bladders portions, a head-back portion and a leg portion. The head-back portion generally supports the patient's head and back while the leg portion generally supports the thighs, legs and feet of the patient. In other embodiments, the support layer 112 includes more portions, for example splitting the head-back portion into distinct head and back portions, adding a seat portion and splitting the leg portion into a feet portion, a lower leg portion and a thigh portion. The bladders can be grouped in sections or provided independently. The whole series of inflatable support bladders 114 is considered to form the second layer.

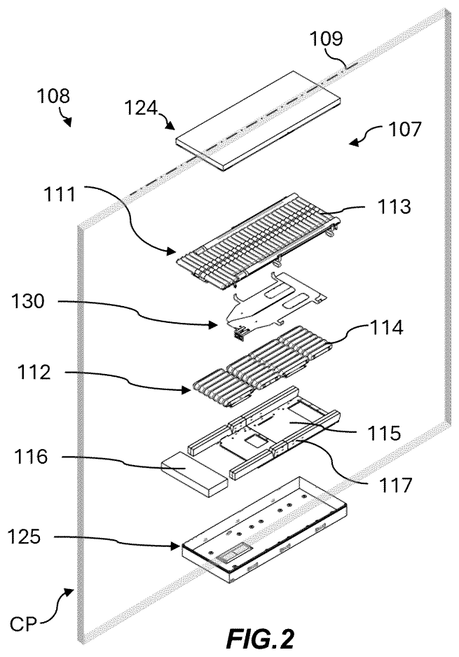

As shown in FIG. 2, the mattress core 110 may also include a foam layer 115 below the support layer 112. The foam layer 115 may impart additional rigidity or structure to the mattress 100. In some embodiments, the mattress core 110 may also include a longitudinal side layer 117 located on sides of the first and the second layer to impart additional rigidity or structure to the mattress 100. The foam layer 115 and the longitudinal side layer 117 may be considered as “structural layers”.

The mattress 100 includes various controlled inflatable components in fluid communication with a pneumatic control assembly 116 which controls air flow to the various air-powered components of the mattress 100, as shown in FIGS. 2 and 3. The pneumatic control assembly 116 may include blowers, compressors, pumps or any combination of these components. This may enable the mattress 100 to provide a range of therapeutic functionalities. In one embodiment, the pneumatic control assembly 116 is enclosed within the mattress cover 120 and is disposed underneath the support layer 112 at the foot end 102. The pneumatic control assembly 116 could be disposed elsewhere along the mattress 100 in other embodiments. In other embodiments, the pneumatic control assembly 116 could be disposed externally to the mattress 100, for example in a separate control unit that can be disposed next to the mattress 100 (e.g., hung at a footboard of the bed on which the mattress 100 is disposed). The pneumatic control assembly 116 is in communication with a control unit and associated user interface 150 that may be integrated into the patient support apparatus to operate and control the mattress 100 as desired.

The pneumatic control assembly 116 may include one or more controller units, one or more processors, one or more memories, one or more input/output interfaces and communication interfaces (not shown). It will be appreciated that the pneumatic control assembly 116 is an implementation of a computing device. The mattress 100 or the hospital bed on which it is typically provided may further include a control interface (not shown) operatively connected to the pneumatic control assembly 116 and configured for receiving user inputs for controlling features of the bed or mattress and outputting information relating to the features of the bed, the mattress and/or the patient. The control interface could be integrated into the footboard, into the headboard or into one or more of the siderails of the bed. Alternatively, the control interface could be integrated into the mattress. Alternatively, it could be provided as a separate unit located near the bed or mattress or even at a location remote from the bed or mattress.

A plurality of air tubes (not shown) fluidly connects the pneumatic control assembly 116 to the inflatable comfort bladders 113 and the inflatable support bladders 114. It is contemplated that the air tubes could also connect the pneumatic control assembly 116 to any other bladder of the mattress 100 (such as microclimate management bladders, percussion vibration bladders, etc.). The pneumatic control system can inflate, maintain inflation, and deflate (using vent valves or vacuum) the different bladders of the mattress 100.

The pneumatic control assembly 116 may include one or more controller units, one or more processors, one or more memories, one or more input/output interfaces and communication interfaces (not shown). It will be appreciated that the pneumatic control assembly 116 is an implementation of a computing device. The mattress 100 or the hospital bed on which it is typically provided may further include a control interface (not shown) operatively connected to the pneumatic control assembly 116 and configured for receiving user inputs for controlling features of the bed or mattress and outputting information relating to the features of the bed, the mattress and/or the patient. The control interface could be integrated into the footboard, into the headboard or into one or more of the siderails of the bed. Alternatively, the control interface could be integrated into the mattress. Alternatively, it could be provided as a separate unit located near the bed or mattress or even at a location remote from the bed or mattress.

The mattress cover 120 (also referred to as ticking) includes a top surface 121, a bottom surface 122, and peripheral surfaces 123 extending from the top surface 121 to the bottom surface 122. The top surface 121 is closest to the patient (e.g., directly contacts the patient if no bedding sheets are used on the mattress), while the bottom surface 122 is closest to the patient support apparatus. The distance between the top surface 121 and the bottom surface 122 defines a thickness, extending along a vertical orientation of the mattress 100. The mattress cover has a top cover 124 and a base cover 125 that is selectively detachable via a zip fastener 126 coupled to the peripheral surfaces 123.

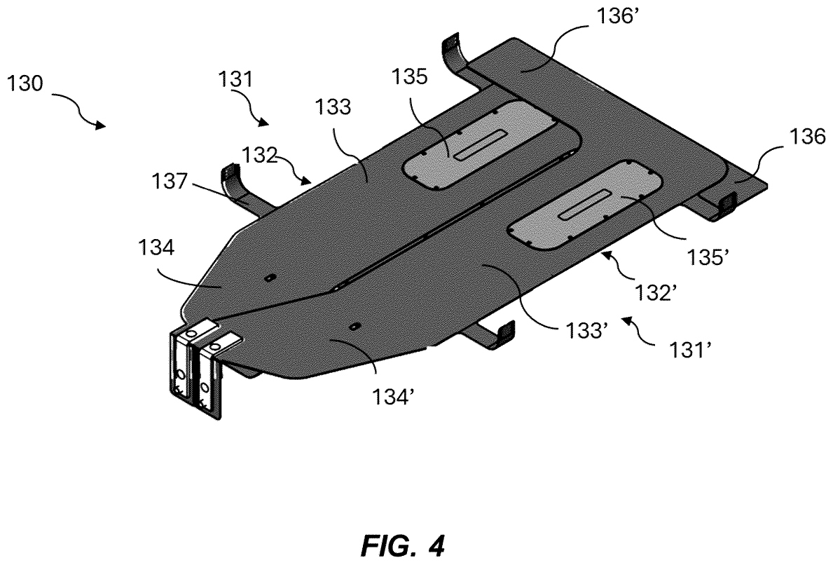

The mattress core 110 has an anatomical turn insert 130 disposed between the support layer 112 and the comfort layer 111. As shown in FIGS. 4-6, the anatomical turn insert has two turn bladders 131, 131′. Turn bladders 131 and 131′ are substantially arranged on the left side 107 and the right side 108 of the mattress 100. Turn bladders 131, 131′ are in mirror symmetry relative to a longitudinal center plane (not shown) of the mattress 100 (i.e., a vertical plane bisecting the width of the mattress 100). Turn bladder 131 will now be described in more detail but it should be understood that turn bladder 131′ would have the same characteristics as turn bladder 131. As a non-limiting example, the mattress 100 may have an overall length in the range of about 170 cm to about 230 cm, for example about 220 cm.

In an example embodiment, turn bladder 131 includes a plurality of portions 132, each serving to tilt a specific part of the patient's body during the turn-assist and the CLRT functions.

The plurality of portions 132 includes a longitudinal torso portion 133, which extends substantially parallel to the longitudinal direction of the mattress 100 near the back section 104. The longitudinal torso portion 133 is an elongated body between a first end 133A near the back section 104 and a second end 133B near the head section 103. This portion is strategically positioned to align with one side of the patient's pelvis, providing targeted support. As a non-limiting example, the longitudinal torso portion 133 may have a length between 70 cm and 90 cm, for example 83 cm.

In addition to the longitudinal torso portion 133, the plurality of portions 132 includes an oblique thigh portion 134. This section is coupled to and extends obliquely from the longitudinal torso portion near the thigh section 105, more precisely near the first end 133A. The oblique thigh portion 134 is re-entrant, i.e., extends from the longitudinal torso portion 133, which is situated at one of the left side 107 and the right side 108 of the mattress 100, towards a second one of the left side and the right side of the mattress 100. The oblique orientation contributes to a more natural alignment with the patient's buttock and thigh. By integrating this oblique thigh portion, the turn bladder 131 will have more surface contact with the patient's body reducing the pressure on the torso of the patient while being inflated and deflated to laterally tilt the patient. The oblique thigh portion 134 helps tilt the thigh together with the back and bend the knee of the patient during turn-assist and CLRT functions. As a non-limiting example, the oblique thigh portion 134 may have a length between 25 cm and 50 cm in a deflated state, for example 40 cm. As will be readily understood, once inflated the oblique thigh portion 134 will have an increased thickness and a reduced length between 15 cm and 40 cm, for example 30 cm.

In other embodiments, a recess or concave region may be provided between the longitudinal torso portion 133 and the oblique thigh portion 134 to create a relief area configured to accommodate and partially unload the patient's buttocks, thereby improving comfort and pressure distribution in the sacral region.

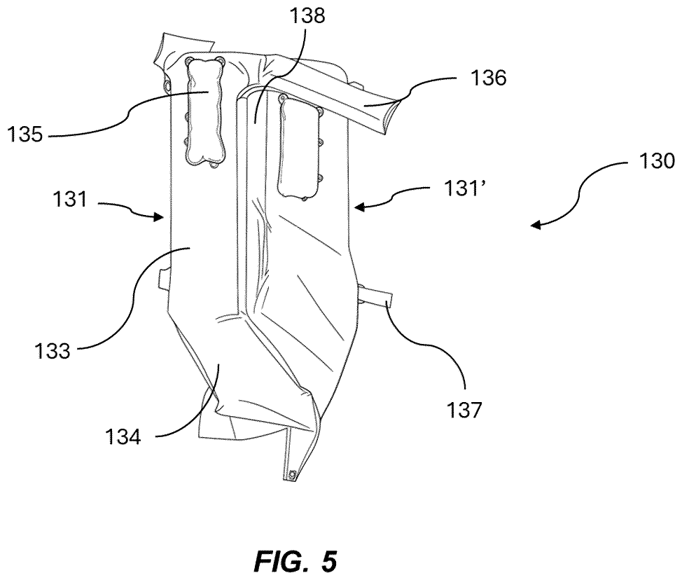

The plurality of portions 132 includes a shoulder support portion 135, which is coupled to and disposed vertically adjacent to the longitudinal torso portion 133 near the head section 103, more precisely near the second end 133B. As used herein, the vertical axis corresponds to the thickness (or height) direction of the mattress. For example, the shoulder support portion 135 may be above the longitudinal torso portion 133. This configuration results in two vertically superposed layers, providing additional support to the upper body during the turn-assist function. The shoulder support portion 135 contributes to maintaining proper posture and alignment, by preventing the shoulder from dropping during turn-assist and CLRT functions. As a non-limiting example, the shoulder support portion 135 may have a length between 35 cm and 45 cm in a deflated state, and between 30 and 40 cm when inflated. The shoulder support portion 135 may be disposed above the longitudinal torso portion 133, as shown in FIGS. 4 and 5. In another embodiment, the shoulder support portion 135 is disposed under the longitudinal torso portion 133.

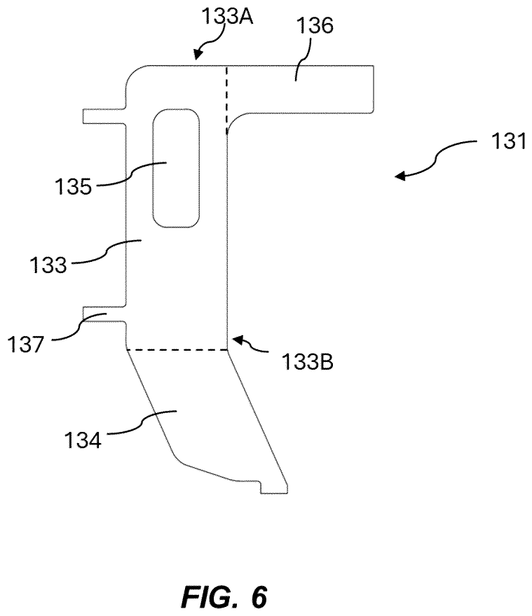

The plurality of portions 132 includes a transversal head portion 136, which is coupled to and substantially perpendicular to the longitudinal torso portion 133 near the head section, more precisely near the second end 133B. Overall, as more apparent in FIG. 6, the turn bladder 131 forms a generally C-shaped configuration when provided with transversal head portion 136, longitudinal torso portion 133 and oblique thigh portion 134. As a non-limiting example, the transversal head portion 136 may have a length between 65 cm and 80 cm in a deflated state and between 60 cm and 75 cm when inflated.

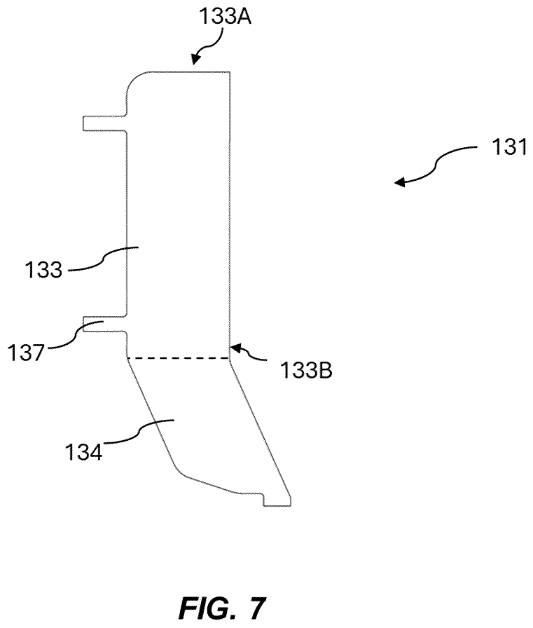

It should be understood that many combinations of portions 132 are possible combining the longitudinal torso portion 133, which is the main element for the turn-assist insert, with other ones of the plurality of portions 132 mentioned above. All of these combinations of portions are envisioned as viable embodiments. FIGS. 7 to 9 present different examples of possible configurations of the turn bladder 131.

Referring to FIG. 7, one example embodiment includes longitudinal torso portion 133 and oblique thigh portion 134. In this embodiment, transversal head portion 136 and shoulder support portion 135 are not provided.

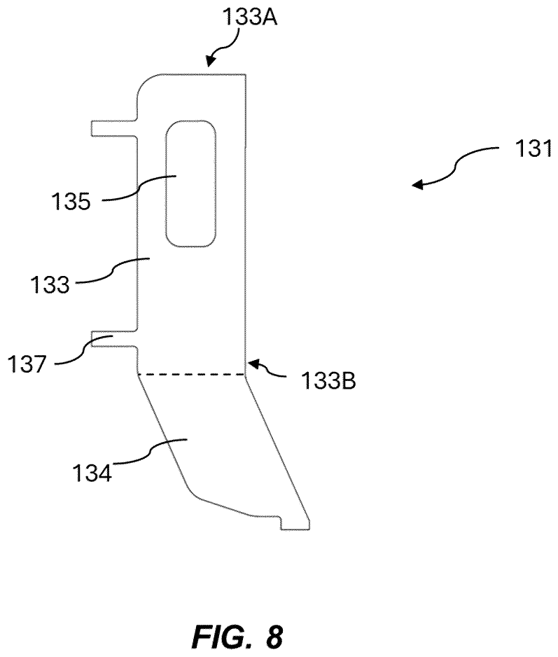

With reference to FIG. 8, another embodiment includes longitudinal torso portion 133, oblique thigh portion 134 and shoulder support portion 135. In this embodiment, transversal head portion 136 is not provided.

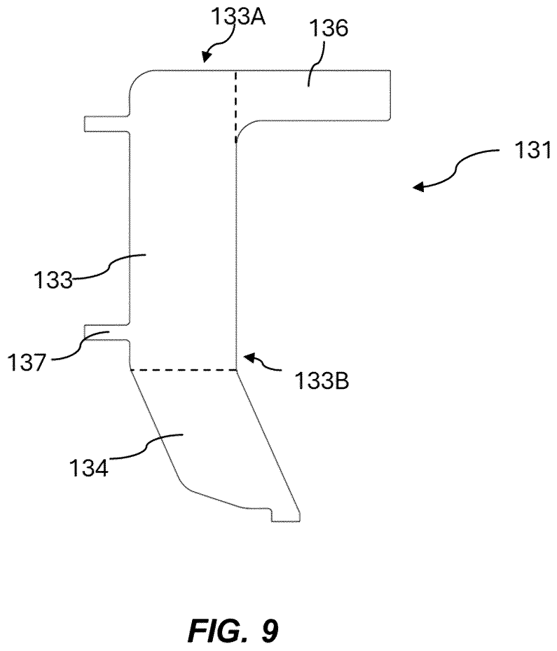

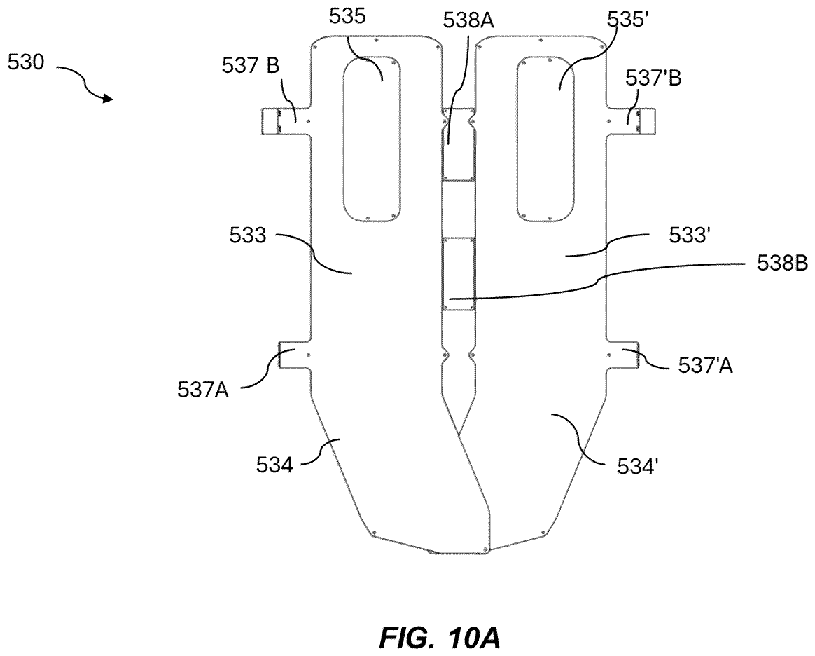

Another embodiment, with reference to FIG. 9, includes longitudinal torso portion 133, oblique thigh portion 134 and transversal head portion 136. In this embodiment, shoulder support portion 135 is not provided.

In other embodiments, the turn bladder 131 may include a plurality of longitudinal torso portions (not shown). The plurality of longitudinal torso portions can be selectively inflated, either entirely or partially, depending on the patient's size, morphology, or therapeutic needs. This modular configuration allows the system to adapt more precisely to different patient profiles, thereby enhancing comfort and ensuring effective turning and CLRT functions across a wider range of body dimensions.

In further embodiments, the turn bladder 131 may include longitudinal torso portion 133 in combination with multiple oblique thigh portions (not shown). Each oblique thigh portion is coupled to the longitudinal torso portion 133 at different longitudinal levels. This arrangement permits selective inflation of one or more oblique thigh portions depending on the patient's size and positioning requirements. Such adaptability enables targeted support of the lower body while minimizing unnecessary pressure on other regions, thereby improving both pressure redistribution and overall patient stability during turn-assist and CLRT functions.

In some embodiments, the anatomical turn insert 130 is secured to the peripheral surfaces 123 of the cover 120 of the mattress 100 using straps 137.

Alternatively, in other embodiments, the anatomical turn insert 130 could be secured, via straps, to other elements of the mattress 100 such as the support layer 112, the comfort layer 111, the foam layer 115, the top surface 121, or the bottom surface 122.

In other embodiments, the anatomical turn insert 130 is permanently secured, for example by welding, to one or more elements of the mattress 100, thereby forming an integral part of the mattress 100.

In other embodiments, alternative securing mechanisms may be employed, such as apertures configured to engage with protrusions, or other equivalent attachment means. In other embodiments, the anatomical turn insert 130 is welded to other elements of the mattress 100 and is an integral part of the mattress.

In further embodiments, the anatomical turn insert 130 is independent of the mattress 100. In such a configuration, the anatomical turn insert 130 could be selectively placed within, beneath, or on the mattress 100 or any other support surface.

It should be understood that turn bladder 131′ has a plurality of portions 132′ symmetrical to the plurality of portions 132 of turn bladder 131. Therefore, the plurality of portions 132′ may include a longitudinal torso portion 133′, an oblique thigh portion 134′, a transversal head portion 136′ and a shoulder support portion 135′, or any other configuration comprising at least one of these portions.

The plurality of portions 132, 132′ may be formed of materials that are suitable for radiofrequency (RF) welding. For instance, the plurality of portions 132, 132′ may be formed of thermoplastic polyurethane (TPU) material. For additional strength, in this embodiment, the plurality of portions further includes a nylon material, laminated with or coated to the TPU material for additional strength. Other fabrics are contemplated in other embodiments.

In an example embodiment, two pieces of fabric are RF welded together to form the longitudinal torso portion 133, the transversal head portion 136, and the oblique thigh portion 134. Two other pieces of fabric are RF welded together to form the shoulder support portion 135. The shoulder support portion 135 and the other ones of the plurality of portions 132 are RF welded to form the plurality of portions 132. Other process methods are contemplated to form the plurality of portions 132 in other embodiments.

The plurality of portions 132 of the turn bladder 131 may form a single pneumatic zone allowing the controller to control inflation and deflation of the turn bladder 131 in its entirety. In this embodiment, the plurality of portions 132 may be selectively inflated and deflated integrally as a single unit.

In another embodiment, the plurality of portions of the turn bladder 131 may form a plurality of independent pneumatic zones. The controller is therefore configured to selectively control inflation and deflation of each independent pneumatic zone independently. For example, each one of the independent pneumatic zones may correspond to one of the plurality of portions, i.e., the longitudinal torso portion 133 may be a first independent pneumatic zone, the oblique thigh portion 134 may be a second independent zone, the transversal head portion 136 may be a third independent pneumatic zone and the shoulder support portion 135 may be a fourth independent zone.

As a non-limiting example, the mattress 100 may have an overall thickness (or height) of between about 7 inches and about 10 inches, for instance about 8 inches, when the turn bladders 131, 131′ are in a deflated state. In this configuration, the base cover may have a height of about 6 to 8 inches and the top cover may have a height of about 1 to 3 inches.

When at least one of the turn bladders 131, 131′ is fully inflated, each turn bladder may have a thickness of about 6 to 10 inches. In such an inflated state, the overall mattress thickness near the region of the inflated turn bladder increases to a greater value, for example to about 16 inches. Other dimensions for the mattress and its components may also be used.

In some embodiments, the anatomical turn insert further comprises at least one securing member to couple the anatomical turn insert to the core and/or the cover. The securing member is, for example, configured to secure the insert to the mattress structure and to interconnect the two turn bladders so as to contribute to stability during turn assist therapy and CLRT therapy. These securing members, which may include straps, bands, patches, or welded joints, contribute to limiting undesired movement or displacement of the insert relative to the mattress and contribute to maintaining the relative position of the two turn bladders when the turn bladders are inflated or deflated. The presence of such securing members contributes to allowing the patient to remain properly supported and to delivering the turn assist therapy in a stable, predictable, and safe manner.

In some embodiments, the anatomical turn insert 130 includes a longitudinal patch 138 extending along a portion of the longitudinal torso portion 133, as shown in FIG. 5. The patch 138 may be flexible or may include additional material so that the turn bladders 131, 131′ do not affect patient immersion.

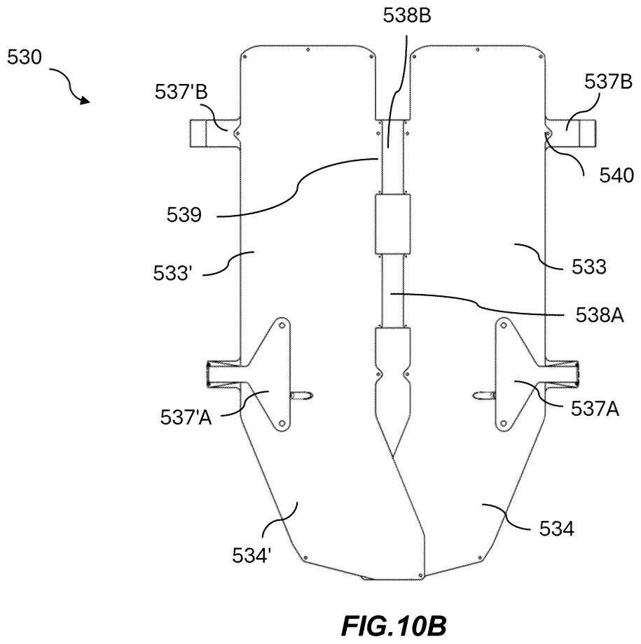

In other embodiments, as shown in FIGS. 10A and 10B, the anatomical turn insert 530 includes one or more transversal bands, for example, two transversal bands 538A, 538B, linking the two turn bladders 531 and 531′ together. 12 The transversal bands 538A, 538B may be connected, by welding, sewing or other suitable process, to a flap or an addition section of material 539 extending from the turn bladders 531, 531′.

The transversal bands 538A, 538B may be flexible so as not to affect the immersion of the patient on the mattress. As a non-limiting example, the transversal bands 538A and 538B may be made of a polyurethane-coated polyester stretch knit, a thermoplastic polyurethane (TPU) film, a coated textile composite, a multilayer elastomeric laminate, or any other flexible or semi-flexible material providing adequate tensile strength and elasticity to maintain the linkage without restricting bladder inflation and deflation.

In other embodiments, the transversal bands may be directly joined to the turn bladders.

As stated above, the anatomical turn insert 130 may be secured to the mattress 100 by securing members that extend from the turn bladders 131, 131′ (FIG. 5).

In other embodiments, such as those presented in FIGS. 10A and 10B, the securing members comprise straps 537A, 537′A, that are routed to encircle or partially wrap around a portion of the core of the mattress (such as the foam layer for example) to anchor the anatomical turn insert 130. Other straps 537B, 537′B may also be present to link the anatomical turn insert 530 to other mattress elements to add more stability during inflation and deflation of the turn bladders 531, 531′.

The straps may be affixed by welding, sewing or other suitable process, to a flap or an additional section of material 540 extending from the turn bladders 531, 531′.

The straps may employ buckles, hook-and-loop, tie-downs, cinch mechanisms, or equivalent fasteners.

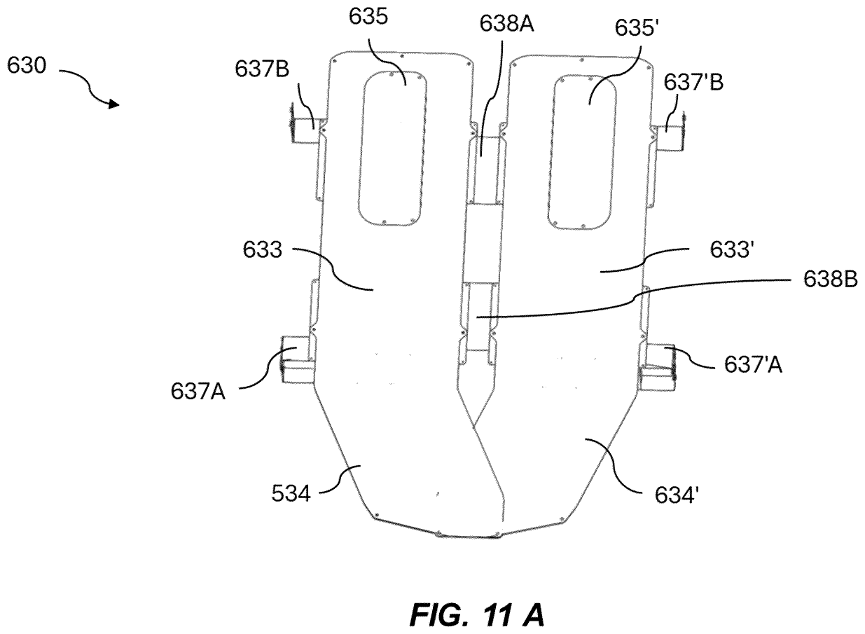

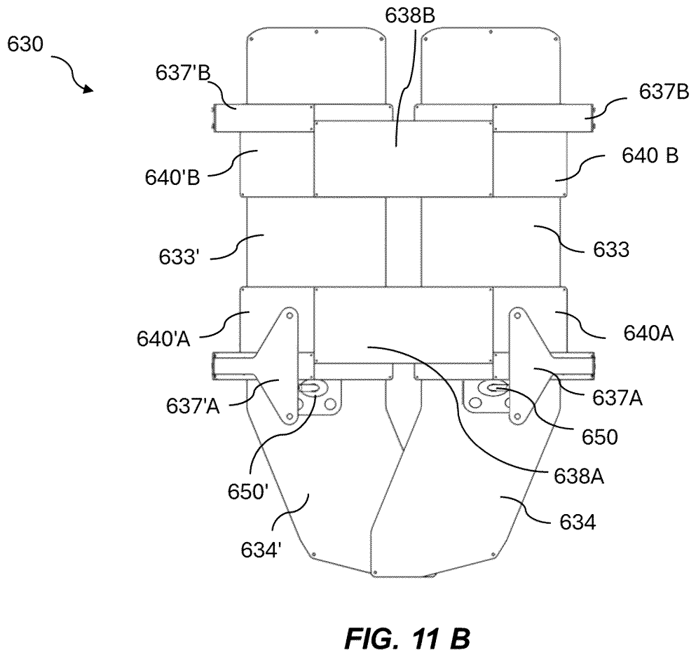

Turning now to FIGS. 11A and 11B, in other embodiments, an anatomical turn insert 630 includes one or more transversal connecting members extending between the turn bladders 631, 631′, for example two transversal bands 638A, 638B.

The transversal bands 638A, 638B may be flexible or may include additional material so that the anatomical turn insert 630 does not affect the immersion.

The anatomical turn insert 630 also comprises four intermediate layers 640A, 640B, 640′A and 640′B. The intermediate layers 640A, 640B are joined beneath the turn bladders 631, 631′ in a manner that does not affect their inflating and deflating, for example, by joining only along longitudinal or transverse edges, or by localized stitching, bonding, or other flexible connections that allow relative motion between the sub layers during inflation and deflation of the turn bladders 631, 631′. The intermediate layers 640A, 640B are configured to provide mechanical linkage between a first turn bladder 631 and a second turn bladder 631′ via transversal bands 638A, 638B or between the anatomical turn insert 630 and other mattress components via straps 637A, 637′A, 637B and 637′B, in a manner that maintains the overall stability of the anatomical turn insert 630 during inflation and deflation of the turn bladders 631, 631′.

In some embodiments, the anatomical turn insert further comprises at least one inlet connector configured to enable controlled fluid communication between the pneumatic control assembly and the at least one turn bladder. In the example embodiment shown in FIG. 11B, the inlet connectors are quarter-turn connectors 650, 650′ directly connected to portions of the turn bladders, such as longitudinal torso portions 633, 633′.

In other embodiments, the inlet connectors may be connected to a manifold or to any other section being in fluid communication with the turn bladders and configured to distribute air to a plurality of portions of the turn bladders. In other embodiments, the comfort layer 111 or the support layer 112 may be subdivided into two longitudinal pneumatic zones extending along the left and right sides of the mattress 100. One of these zones may be selectively deflated (partially or fully) while the other zone remains inflated, thereby biasing the patient toward the deflated zone to enhance the turning effect produced by the turn bladders 131, 131′.

The turn-assist function will now be described in more detail. As mentioned above, the turn bladders 131 and 131′ may be used as part of the turn-assist function to turn a patient toward either lateral side of the mattress 100. When it is not required to turn the patient, the turn bladders 131, 131′ can remain deflated. When the turn-assist function is activated, the controller controls the inflation of one of the turn bladders 131, 131′ to a predetermined inflation pressure, while keeping the other one of the turn bladders 131, 131′ deflated. As the turn bladders 131, 131′ are disposed below the comfort layer 111 (and in some embodiments, between the comfort layer 111 and the support layer 112), the inflation of one of the turn bladders 131, 131′ elevates a portion of the comfort layer above the inflated turn layer, thereby tilting the patient lying on the mattress 100 laterally. For example, the turn bladder 131 can be inflated to an inflation pressure between 25 mmHg and 45 mmHg, for instance about 35 mmHg within about 15 seconds as a non-limiting example. The patient thereby being laterally tilted to a tilting angle of 20 to 50 degrees for example, such as 30 degrees as a non-limiting example. The turn bladder 131 can remain inflated until the caregiver decides to finish the turn-assist function or can be controlled to be on a timer, deflating after a predetermined period of time. Additionally, the turn bladder 131 can be inflated to a pressure that achieves less than the maximum tilting angle. The caregiver can also stop the inflation before reaching the maximum tilting angle.

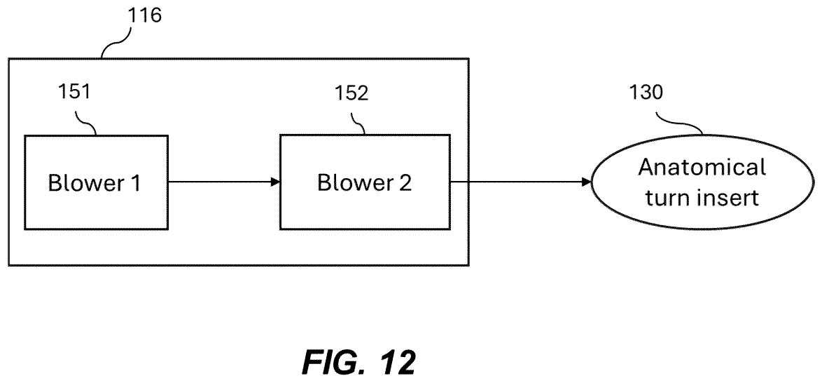

Turning now to FIG. 12, in this embodiment, the pneumatic control assembly 116 may include multiple blowers that are fluidly connected in series ensuring a multiple stage compression mode. For example, the pneumatic control assembly 116 may have a first blower 151 and a second blower 152 ensuring a dual stage compression mode wherein the first blower pumps air to the second blower, and the second blower receives the pumped air and then further pumps the pumped air delivering a dual compressed air to the turn bladder 131. The dual compressed air delivered to the turn bladder 131 with more air pressure and more inflation flow rate compared to the air pressure and the inflation flow rate that would be delivered to the turn bladder 131 if only one blower is used. This configuration provides higher air pressure and more rapid flow the turn bladder 131 compared to using a single blower. This design provides a rapid inflation of the turn bladder 131 within 15 seconds.

As will be readily understood, advanced controls may be provided for the caregiver on the user interface to specify the predetermined inflation pressure and/or time.

In addition to the turn-assist function, a continuous lateral rotation therapy (CLRT) function can also be provided using the anatomical turn insert. The CLRT function is used to alternate inflation and deflation the turn bladders 131, 131′.

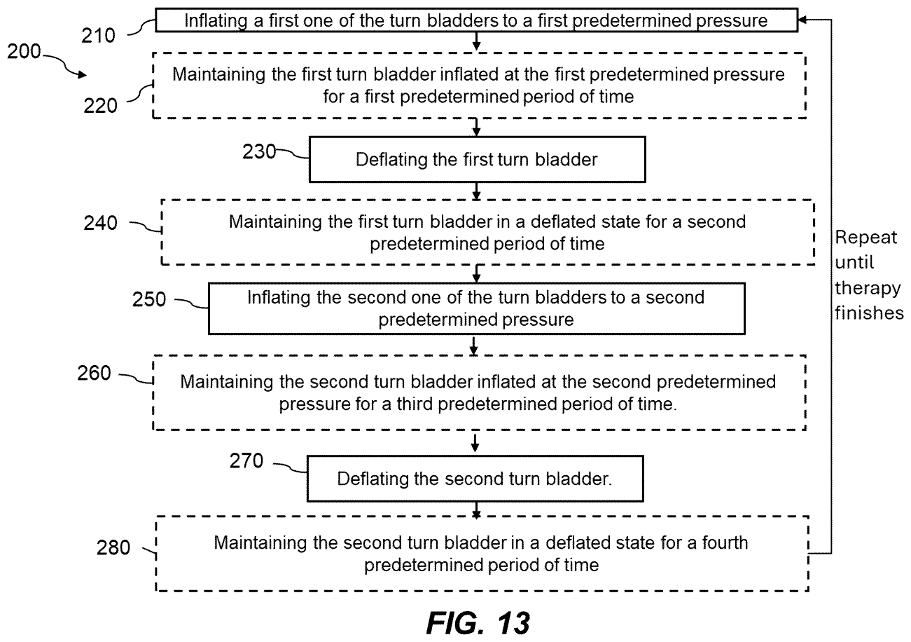

An example of a method 200 for a CLRT will now be described with reference to FIG. 13. In one or more embodiments, the method 200 is executed by a controller programmed to control an alternating inflation/deflation cycle, such as a controller of the pneumatic system.

In one or more embodiments, the method 200 is stored in the form of instructions in a non-transitory storage medium and executed by a processing unit of the controller. As will be understood, the controller includes at least a processor and a memory. Additionally, the controller may include or be operatively connected to one or more input/output interfaces and communication interfaces. The processors which may also be referred to as processing devices, or processing units, may each include a single-core microprocessor. In one or more other implementations, a given one of the processors may include a multi-core microprocessor. In one or more alternative implementations, a given one of the processors may include one or more of: a microcontroller, a digital signal processor (DSP), an integrated circuit purposed for specific operations within an embedded system, a microprocessor, a system on a chip (SoC), a field-programmable gate array (FPGA), and an application-specific integrated circuit (ASIC) configured to carry out the processing and functionalities described herein. The memories may include volatile and non-volatile memories. In one or more implementations, a given one of the memories may include volatile memory, such as random-access memory (RAM), and/or alternatively static random-access memory (SRAM) or dynamic random-access memory (DRAM). In one or more implementations, a given one of the memories may include non-volatile memory, such as flash memory and/or alternatively electrically erasable programmable read-only memory (EEPROM) or ferroelectric RAM (FRAM). The memories are configured to store computer-readable instructions executable by the processors to carry out the processing and functionalities described herein.

The cycle begins, at step 210, where the controller causes inflation of a first one of the turn bladders 131, 131′ to a first predetermined pressure.

After inflating the first turn bladder to the first predetermined pressure, at step 220, the controller maintains the first turn bladder inflated at the first predetermined pressure for a first predetermined period of time. The patient lying on the mattress 100 is therefore laterally tilted to a predetermined tilting angle. For example, the predetermined tiling angle could be between 20 and 50 degrees.

Once the first predetermined period of time has passed, at step 230, the controller causes deflation of the first turn bladder.

After deflating the first turn bladder, at step 240, the controller maintains the first turn bladder in a deflated state for a second predetermined period of time.

At step 250, the controller causes inflation of the second one of the turn bladders 131, 131′ to a second predetermined pressure.

After inflating the second turn bladder to the second predetermined pressure, at step 260, the controller maintains the second turn bladder inflated at the second predetermined pressure for a third predetermined period of time.

Once the second predetermined period of time has passed, at step 270, the controller causes deflation of the second turn bladder.

At step 280, the controller maintains the second turn bladder in a deflated state for a fourth predetermined period of time.

The controller repeats the alternating inflation/deflation cycle continuously until the caregiver decides to end the turn-assist function and/or a third predetermined period of time elapses. The method 200 then ends.

In some embodiments, any one of the first predetermined period of time, the second predetermined period of time, the third predetermined period of time or the fourth predetermined period of time may be equal to 0 seconds. This is equivalent to the step being omitted.

Method 200 presents an example of an inflation and deflation cycle for performing CLRT therapy; however, other cycles are also possible. For example, one or more of the maintaining steps described above may be omitted. In some embodiments, inflation of one of the turn bladders may be performed substantially simultaneously with deflation of the other turn bladder. In general, to perform CLRT therapy, the steps of inflating, and deflating of the first turn bladder are performed in a temporally offset manner relative to the corresponding steps of the second turn bladder, such that both turn bladders are not inflated at the same time (similarly for the deflating step). As will be readily understood, if the turn bladders 131, 131′ have a plurality of independent pneumatic zones, inflation sequences can be pre-programmed within the controller to inflate different portions of the turn bladder in a specific order to provide a more precise therapy. Alternatively, or additionally, control options can be provided on the user interface to enable the caregiver to indicate the inflate/deflation sequence or specific zones to inflate/deflate in both the turn-assist function and the CLRT.

As will be readily understood, in some embodiments, variations on the basic therapy sequence can be provided, such as a partial inflation/deflation sequence as an alternative to a complete or full inflation/deflation sequence to better control a rotation of the patient, for example providing a less abrupt change in his lateral orientation. The partial inflation/deflation level could evolve over time in a more advanced therapy sequence. Also, in certain embodiments, one of the turn bladders 131, 131′ may be inflated to a greater extent than the other. Such asymmetric inflation may be desirable, for example, when accommodating a patient with an injury, wound, or localized sensitivity on one side of the body. By enabling a differential level of support between the turn bladders 131, 131′, the system can provide more tailored off-loading, reduce localized pressure, and increase patient comfort while still assisting in patient turning.

It should also be understood that the plurality of portions would be aligned to different members of the body of the patient depending on whether the patient is positioned on the support in a supine position (on their back), which is the basic position described herein, or in a prone position (on their ventral side). For example, in some embodiments, the longitudinal torso portion would be aligned with a lateral part of the chest and the abdomen of the patient if the patient is lying in a prone position. In this case, the turn-assist function would help caregivers to turn the patient from the prone position to the supine position.

In some embodiments, the mattress 100 is also adapted to provide a prone therapy configuration by deflating some of the inflatable comfort bladders 113 and the inflatable support bladders 114. In one embodiment, the prone therapy configuration includes deflating some of the inflatable comfort bladders 113 and the inflatable support bladders 114 that are aligned with the head of the patient when they are lying in a prone position to provide clearance for the head of the patient. In other embodiments, the prone therapy configuration further includes deflating some of the inflatable comfort bladders 113 and the inflatable support bladders 114 that are aligned with the feet of the patient when the patient is lying in a prone position to provide clearance for the feet of the patient.

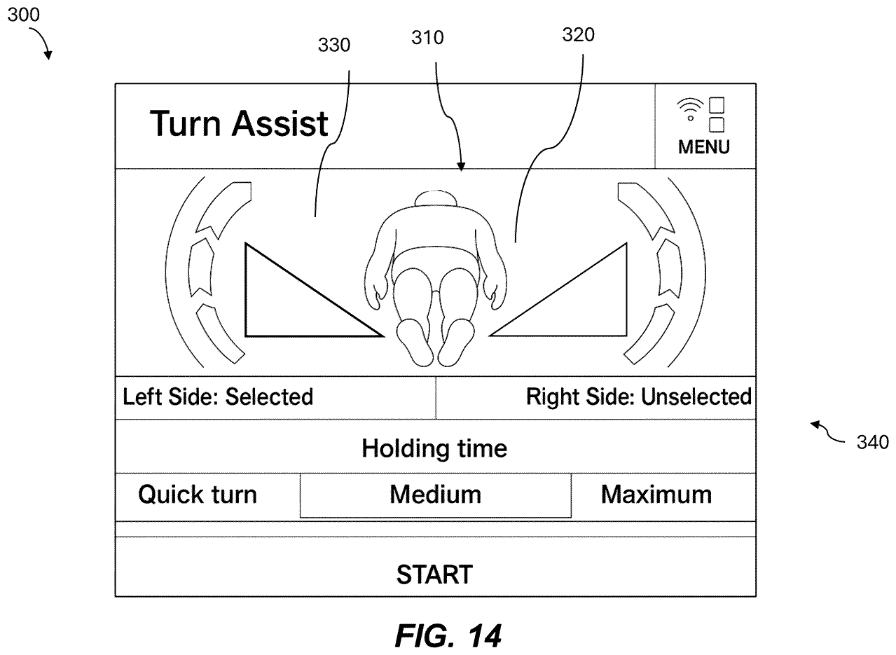

With reference to FIG. 14, there is shown an example of a turn-assist GUI 300 in accordance with non-limiting embodiments of the present disclosure.

The turn-assist GUI 300 may be accessible via a home GUI (not shown) on a control panel associated with the bed or mattress 100.

The turn-assist GUI 300 includes a main central section 310 depicting a patient lying at the center of the mattress divided into two operational zones: left side section 320 and right side section 330. One of the left side section 320 or the right side section 330 may be selected on the turn-assist GUI 300 to perform a left side turn-assist or right side turn-assist, respectively. As shown in FIG. 14, the left side section 320 portion is emphasized to visually differentiate selected portions from unselected portions.

Below the main central section 310, a time section 340 enables the user to select between different preselected operational time settings, such as maximum, medium and quick turn. Each setting corresponds to a preselected holding time during which the selected operational zone remains in an inflated state. In the example shown in FIG. 14, the selected configuration of a medium holding time is emphasized. In some embodiments, the operational time duration may be selected directly by the user, such as 15 minutes, 30 minutes and 1 hour and 30 minutes. A start button 350 at the bottom enables the user to confirm and start the turn-assist function.

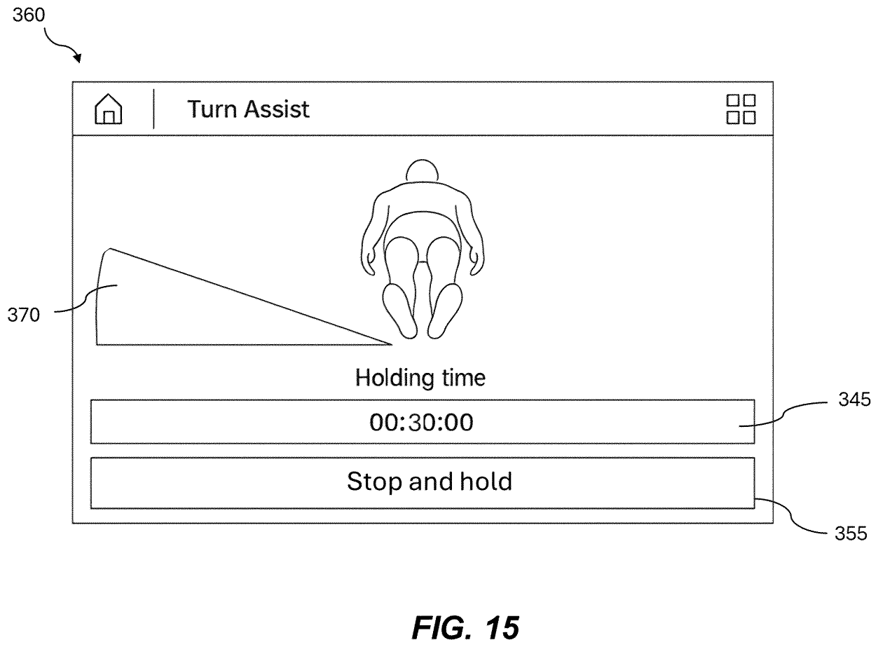

Turning now to FIG. 15, there is shown an example of a progress turn-assist GUI 360. In this example, the user has selected the left-side turn-assist on turn-assist GUI 300. Upon selection, progress of the time remaining in the turn-assist is shown as a circular progress arc 370, where the area in a darker shade represents the time that has passed and the area in a lighter shade represents the time remaining to the turn-assist function. The time section 340 shows a remaining time sub-section 345 (for example, a remaining time of 30 minutes is shown in FIG. 13). A “stop and hold” button 355 is shown at the bottom, which enables stopping the execution of the turn-assist function.

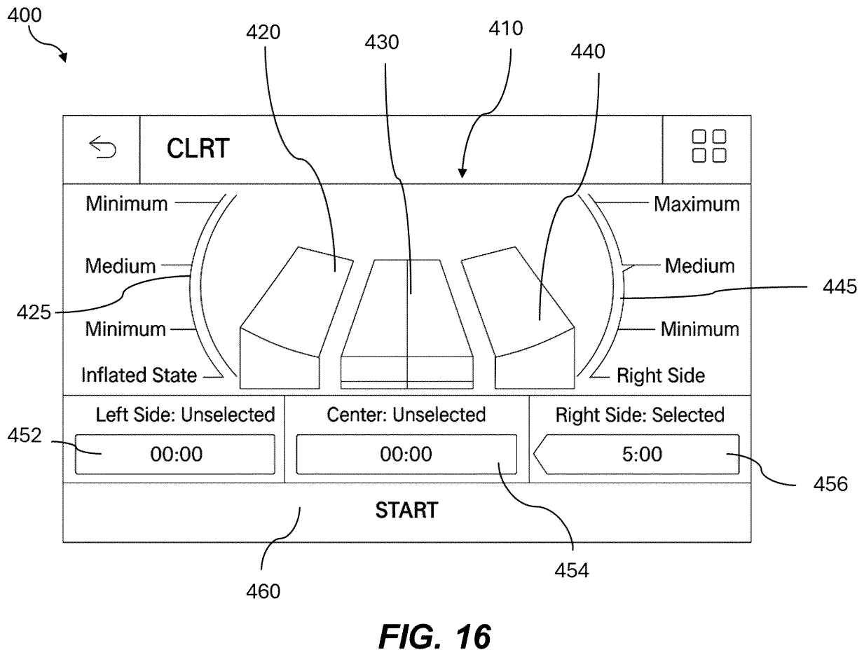

In one or more embodiments, a CLRT GUI 400 may be accessed via a home GUI (not shown) on the control panel associated with the bed or the mattress 100 (not shown). With reference to FIG. 16, an example of a CLRT GUI 400 is shown in accordance with non-limiting embodiments of the present disclosure.

The CLRT GUI 400 includes a main section 410 corresponding to a perspective view of the mattress divided into three zones including a left zone 420, a central zone 430, and right zone 440. A left circular progress bar 425, indicating a left side CLRT intensity level (maximum, medium, minimum and deflated state), and right circular progress bar 445, indicating a right side CLRT intensity level 445 (maximum, medium, minimum and deflated state) are shown at the left side and right side of the main section 410.

A timer section 450 includes a left side timer 452 to set a time duration for CLRT on the left side, a center timer 454 enables setting a time duration for CLRT in the center, and right side timer 456 enables setting a time duration for CLRT on the right side. It will be appreciated that different durations may be set by the user.

It will be appreciated that if no selection of intensity levels and/or timers is performed by a user, default values may be used to perform the CLRT functionality.

The CLRT GUI 400 includes a start button 460 at the bottom to start the CLRT functionality according to the selected intensity levels and the selected time durations. In one or more embodiments, a user clicking on start button 460 causes execution of the method 200.

The embodiments described above are intended to be exemplary only.

1. A support surface for a patient support apparatus, the support surface being adapted for supporting a patient, the support surface having a head section, a back section, a thigh section, and a foot section arranged respectively from a head end to a foot end of the support surface along a longitudinal direction of the support surface, and having a right side and a left side defining a width of the support surface, the right side and the left side being disposed on opposite sides of a central plane of the support surface, the central plane extending parallel to the longitudinal direction and bisecting the width of the support surface, the support surface comprising:
a core having a first layer and an anatomical turn insert, the anatomical turn insert being vertically adjacent to the first layer and having a first turn bladder and a second turn bladder, each being substantially arranged on one of the left side and the right side of the support surface and being substantially in mirror symmetry relative to the central plane, the first turn bladder having a first plurality of portions, the first plurality of portions including a longitudinal torso portion extending substantially parallel to the longitudinal direction near the back section, and an oblique thigh portion coupled to and extending obliquely from the longitudinal torso portion near the thigh section, the second turn bladder having a second plurality of portions being substantially in mirror symmetry to the first plurality of portions relative to the central plane;
a cover, the cover having a top surface, a bottom surface, and peripheral surfaces extending from the top surface and connecting to the bottom surface thereby enclosing the core; and
a pneumatic control assembly having a controller operable to selectively control inflation and deflation of the first plurality of portions and the second plurality of portions.

2. The support surface of claim 1, wherein the first plurality of portions further includes a shoulder support portion coupled to and disposed vertically adjacent to the longitudinal torso portion near the head section, the first plurality of portions thereby including two vertically superposed layers.

3. The support surface of claim 1, wherein the first plurality of portions further includes a transversal head portion coupled to and substantially perpendicular to the longitudinal torso portion near the head section, the first plurality of portions thereby having a generally C-shaped configuration.

4. The support surface of claim 1, wherein the first plurality of portions further includes a transversal head portion and a shoulder support portion, the transversal head portion being coupled to and substantially perpendicular to the longitudinal torso portion near the head section and the shoulder support portion being coupled to and disposed vertically adjacent the longitudinal torso portion, near the transversal head portion.

5. The support surface of claim 1, wherein the first layer is provided between the top surface and the anatomical turn insert.

6. The support surface of claim 1, further comprising a securing member to couple the anatomical turn insert to at least one of the core and the cover.

7. The support surface of claim 6, wherein the securing member is affixed to at least one of an additional section of material of the longitudinal torso portion of at least one of the first and second turn bladders and an intermediate layer at least partially connected to at least one of the first and second turn bladders.

8. The support surface of claim 1, wherein the anatomical turn insert further comprises at least one connecting member, the at least one connecting member being operable to connect the first turn bladder to the second turn bladder.

9. The support surface of claim 1, wherein the core further comprises a second layer, the second layer being located vertically under the anatomical turn insert, wherein the anatomical turn insert is provided between the first layer and the second layer.

10. The support surface of claim 1, wherein the first plurality of portions forms a single pneumatic zone, the controller being thereby operable to selectively inflate and deflate the first plurality of portions integrally.

11. The support surface of claim 1, wherein the controller is programmed to control an alternating inflation/deflation cycle, the alternating inflation/deflation cycle comprising: inflating the first plurality of portions to a first predetermined pressure, maintaining the first plurality of portions inflated at the first predetermined pressure for a first predetermined period of time, deflating first plurality of portions, maintaining the first plurality of portions deflated for a second predetermined period of time, inflating the second plurality of portions to a second predetermined pressure, maintaining the second plurality of portions inflated at the second predetermined pressure for a third predetermined period of time, deflating the second plurality of portions, maintaining the first plurality of portions deflated for a fourth predetermined period of time, repeating the alternating inflation/deflation cycle continuously, a continuous lateral rotation therapy (CLRT) thereby being applied to the patient.

12. The support surface of claim 1, wherein the pneumatic control assembly further includes a first blower and a second blower, the controller being operable to enable the first blower to provide air at a first flow rate and a first pressure, and the second blower at a second flow rate and a second pressure.

13. An anatomical turn insert for a support surface, the support surface being adapted to receive, in use, a patient, the anatomical turn insert comprising:
at least one turn bladder being pneumatically inflatable, the at least one the turn bladder having a plurality of portions, the plurality of portions including a longitudinal torso portion having a first end and a second end and forming an elongated body, and an oblique thigh portion coupled to and extending obliquely from the longitudinal torso portion near to the first end.

14. The anatomical turn insert of claim 13, wherein the plurality of portions further comprises a shoulder support portion coupled to and disposed vertically adjacent to the longitudinal torso portion near the second end, the plurality of portions thereby including two vertically superposed layers.

15. The anatomical turn insert of claim 13, wherein the plurality of portions further comprises a transversal head portion coupled to and substantially perpendicular to the longitudinal torso portion near the second end, the plurality of portions thereby having a generally C-shaped configuration.

16. The anatomical turn insert of claim 13, wherein the plurality of portions further comprises a transversal head portion and a shoulder support portion, the transversal head portion being coupled to and substantially perpendicular to the longitudinal torso portion near the second end and the shoulder support portion being coupled to and disposed vertically adjacent to the longitudinal torso portion, near the transversal head portion.

17. A method for providing a turn assist to a patient, the method comprising:
providing a support surface with an anatomical turn insert as claimed in any one of claims 13 to 16;
inflating the at least one portion of the at least one turn bladder to a first predetermined pressure; and
maintaining the at least one portion inflated at the first predetermined pressure for a first predetermined period of time.

18. The method of claim 17, further comprising deflating the at least first one portion of the at least one turn bladder.

19. The method of claim 18, further comprising maintaining the at least first one portion of the at least one turn bladder in a deflated state for a second predetermined period of time.

20. The support surface of claim 19, wherein at least one of the first predetermined period of time and the second predetermined period of time is 0 seconds.

21. The method of claim 20, wherein the at least one turn bladder includes a first turn bladder and a second turn bladder, the method further comprising performing the steps of inflating and deflating, the first turn bladder in a temporally offset manner relative to the steps of inflating and deflating of the second turn bladder, the method being operable to provide continuous lateral rotation therapy to the patient.
